(19) United States
(12) Patent Application Publication
(10) Pub. No.: US 2004/0241250 A1
(43) Pub. Date: Dec. 2, 2004

(54) Composition and method for banana peel strengthening

(76) Inventor: A. Harry J. Rajamannan, Minneapolis, MN (US)

Correspondence Address: Herman H. Bains, 6101 Tracy Ave, Minneapolis, MN, 55436, US

(21) Appl. No.: 10/448,831

(22) Filed: May 30, 2003

(51) Int. Cl. A01N 59/26

(52) U.S. Cl. 424/601

(57) ABSTRACT

A composition for strengthening the peel of banana and plantain fruits for eliminating speckling of the fruits includes a fertilizer comprising the alkali, acids or salts of certain elements. The fertilizer preferably includes an acid or salt of phosphorous. An organismic substance produced from hydrolyzed bacteria, fungi or viruses is combined with the fertilizer. The composition is injected or foliar sprayed upon the banana and plantain plants.

### FIELD OF INVENTION

This invention relates to compounds that can reduce or eliminate speckling caused by fungus, insects, environment or chemicals to banana fruits.

### BACKGROUND OF THE INVENTION

Banana fruit are susceptible to speckling or spotting on the skin of the fruit while it is on the tree, which can spoil the esthetics of the fruit in the market.

This speckling or spotting is caused by fungus, bacteria, insects and chemicals.

No methods currently exist to address this problem. This speckling leads to disfigurement of the fruits, which means these fruits are thrown away and not packed for the market.

Fungicides, bactericides and insecticides have been applied since the 1950's to control fungi, bacteria, insects and nematodes that attack the plants. These chemical pesticides are not only contaminating the environment, pose a danger to workers, leave traces of pesticides in the produce consumed, but are also becoming quite useless as these pathogens are fast developing resistance to these chemical agents.

U.S. Pat. No. 6,372,238 discloses a process for implanting dry implant sticks into banana and plantain plants for providing nutrients and improving resistance to plant pathogens. The nutrient was slowly released over time and the implant provided reduction of infection by certain pathogens. However, the implant did not obtain the results of the composition of the present invention.

### SUMMARY OF THE INVENTION

An object of this invention is to provide a composition and method of applying the composition for eliminating speckling in banana and plantain fruits.

A more specific object of this invention is to provide a novel composition for preventing and eliminating speckling of fruits of banana and plantain plants in which the composition consists of a nutrient and an extract obtained from fungi, bacteria or viral substance.

The novel composition is injected into or foliar sprayed or banana or plantain plants prior to flowering or after flowering. The nutrient of the composition may be a salt, acid or alkali of phosphorous, potassium, nitrogen, calcium, zinc, manganese, sodium, iron, cobalt or ammonia. The organismic extract is obtained from hydrolyzed Bacillus Subtillis, Trichoderma, or Tobacco Mosaic Virus. The composition is injected into the plant resulting in the prevention of speckling on the fruits and strengthening of the peel of the fruits.

### DESCRIPTION OF THE PREFERRED EMBODIMENT

In treating banana and plantain plants with the novel composition it was found that not only was speckling of the fruit eliminated, but the peel was very noticeably strengthened. The speckling or spotting of the fruit is caused by fungi, bacteria, insects and chemicals. The strengthening or thickening of the peel of fruits is involved in the elimination or prevention of speckling.

The composition includes a nutrient combined with an organismic substance derived from bacteria, fungi or virus. The nutrient includes a salt, acid or alkali of phosphorous, potassium, nitrogen, calcium, zinc, magnesium, manganese, sodium, iron, cobalt or ammonia. Potassium phosphite and calcium phosphite have been found to be especially effective as a fertilizer in the composition.

Microorganisms including Bacillus Subtillis, Trichoderma and Tobacco Mosaic virus are hydrolyzed to produce an extract which is combined with nutrient. The composition is applied to the plants by injection or foliar spray.

### EXAMPLES

In a banana plantation 3 to 4 months prior to flowering the following experiment was established.

Micronorganisms, grown in the laboratory (Bacillus Subtillis, Trichoderma, Tobacco Mosaic Virus) were hydrolyzed and stored for use in this experiment marked extracts.

Fertilizers such as potassium phosphite and calcium phosphite were selected as fertilizers and marked as fertilizers.

1. 24 plants were marked as belonging to Group A were not treated pre or post flowering.

2. 24 plants were marked as belonging to Group B were not treated pre flowering but post flowering (2-3 days) were challenged by spraying on the fruit and flowers with a cocktail of calixin and Mancozeb (well known fungicides used in the banana industry) before bagging the flowers.

3. 24 plants were marked Group C and then were injected with extracts alone at 1 cc per plant monthly for 4 months pre flowering and these fruits were not challenged.

4. 24 plants were marked Group D and then were injected as in Group C and then the fruits were challenged as in Group B.

5. 24 plants were marked Group E and then injected with fertilizer solution 5% of 1 cc per plant for 4 months with monthly injection and then not challenged.

6. 24 plants were marked Group F and then injected with fertilizer as in Group E and then challenged as in Group B.

7. 24 plants were marked Group G and then injected with a combination of extract and fertilizer for 4 months, monthly at 1 cc per plant and then not challenged.

8. 24 plants were marked Group H and then injected as in Group G and then challenged as in Group B above.

Measurements were taken just before harvest to ascertain the efficiency of the treatments.

RESULTS OF SPECKLING

| | AVERAGE SPECKLING |
|---|---|
| A. True Control | 6% |
| B. Control-Challenged | 35% |
| C. Extracts Treated-Not Challenged | 7% |
| D. Extracts Treated-Challenged | 36% |
| E. Fertilizer Treated-Not Challenged | 5% |
| F. Fertilizer Treated-Challenged | 39% |
| G. Combination Treated-Not Challenged | Zero |
| H. Combination Treated-Challenged | Zero |

The above results showed that the combination was the key to strengthen the banana skin.

What is claimed is:

1. A composition for strengthening the peel of banana and plantain fruit for eliminating speckling of the fruit, comprising a fertilizer comprising the salt derived from an element from the group consisting of phosphorous, potassium, nitrogen, calcium, zinc, magnesium, manganese, sodium, iron, cobalt and ammonia, combined with an organismic substance extracted from the group consisting of bacteria, fungi, and viruses for application to banana and plantain plants.

2. A composition for strengthening the peel of banana and plantain fruits for eliminating speckling of the fruit comprising a fertilizer including an acid derived from an element selected from the group consisting of phosphorous, potassium, nitrogen calcium, zinc magnesium, manganese, sodium, iron, cobalt and ammonia, combined with an organisimic substance extracted from the group consisting of bacteria, fungi and viruses for application to banana and plantain plants.

3. A composition for strengthening the peel of banana and plantain fruits for eliminating speckling of the fruit, comprising a fertilizer including an alkali derived from an element selected from the group consisting of phosphorous, potassium, nitrogen, calcium, zinc, magnesium, manganese, sodium iron, cobalt and ammonia,
combined with an organismic substance extracted from the group consisting of bacteria, fungi and viruses for application to banana and plantain plants.

4. The composition as defined in claim 2 wherein the acid is a acid of phosphorous.

5. The composition as defined in claim 4 wherein the acid is calcium phosphite.

6. The composition as defined in claim 4 wherein said acid is potassium phosphite.

7. The process of strengthening the peel of banana and plantain fruits for eliminating speckling of the fruits, comprises
combining a composition comprising a nutrient selected from the group consisting of an acid of phosphorous and a salt of phosphorous,
with a microorgnismic substance selected from the group consisting of hydrolyzed bacteria, fungi and viruses.
and applying the composition to banana and plantain plants.

8. The process as defined in claim 7 wherein the composition is injected into banana and plantain plants.

9. The process as defined in claim 7 wherein the composition is applied to the banana and plantain plants as a foliar spray.

10. The composition as defined in claim 1 wherein the organismic substance is extracted from Bacillus Subtilles.

11. The composition as defined in claim 1 wherein the organismic substance is extracted from Trichoderma.

12. The composition as defined in claim 1 wherein the organismic substance is extracted from Tobacco Mosaic Virus.

13. A composition for strengthening the peel of banana and plantain fruit for eliminating speckling of the fruit, comprising a fertilizer including an acid or salt derived from an element of the group consisting of phosphorous, potassium, nitrogen, calcium, zinc, magnesium, manganese, sodium, iron, cobalt and ammonia,
combined with an organismic substance selected from the group consisting of bacteria, fungi and viruses for application to banana and plantain plants.
